(19) United States
(12) Patent Application Publication
(10) Pub. No.: US 2004/0053188 A1
(43) Pub. Date: Mar. 18, 2004

(54) Orthodontic apparatus with rods

(76) Inventors: Elie Callabe, Vineuil (FR); Jean Charles Morin, Saint Aignan (FR)

Correspondence Address: WILLIAM COLLARD, COLLARD & ROE, P.C., 1077 NORTHERN BOULEVARD, ROSLYN, NY, 11576, US

(21) Appl. No.: 10/380,658

(22) PCT Filed: Sep. 12, 2001
(86) PCT No.: PCT/FR01/02828

(30) Foreign Application Priority Data
Sep. 14, 2000 (FR) 00/11700

(51) Int. Cl. A61C 3/00

(52) U.S. Cl. 433/19

(57) ABSTRACT

The invention concerns a removable orthodontic apparatus with rods used in orthodontics to induce the projection of the lower jaw. The apparatus is characterised in that rods (4, 10) are fixed to a metal frame with a wedge shaped like a ball-hook passing through a tube (7) welded on the metal frame (2, 3, 15) of the apparatus. Said links are characterised in that they consist of a tube comprising at its end a flat surface, for example perpendicular to the axis of the tube and perforated with an eyelet through which passes the ball-hook.

This invention concerns the field of removable orthodontic apparatuses and more particularly a system of rods used in orthodontics to induce the projection of the lower jaw.

The principle of treatment of maxillomandibular displacements consists in using orthodontic apparatuses which propel the mandible forward with resting point on the jawbone in order to bring about a stimulation of mandibular growth toward the front and a decrease of growth of the upper jawbone toward the front. Appropriate apparatuses are used for this purpose.

There is known in particular the Herbst system consisting of two casts connected by two rods each comprising a male part and a female part. The female part is fixed to the upper jaw and the male part is fixed to the mandible. The end of each of these parts comprises an eyelet. The rods are fixed to the casts by means of a screw passing through the eyelet and screwed onto a metal frame built into the cast at the outer arc.

There also are known the rods described in the patent FR2760631 which may be fitted just as well on a multi-fastener apparatus as on an apparatus with removable casts.

These rods are characterized by the fact that the female part terminates in a loop which may be fixed to the upper jaw with a ball-hook and by the fact that the male part terminates with a loop which is closed by crimping for example around a ball-hook, located at the mandible and forming an angle of 90° with this loop.

Other systems, such as those described in the patents FR2754171, WO001048 [sic], U.S. Pat. No. 5,944,518, U.S. Pat. No. 5,879,157 are known, but they all comprise devices for fastening at the mandible which are perpendicular to the teeth of the mandible.

The removable apparatuses have, among others, the following drawbacks:

heavy, uncomfortable and difficult to tolerate

unsightly because they distort the child's face (hamster effect)

they disturb certain oral functions, such as diction, phonation, labial occlusion, etc.

resins casts entirely covering the occlusive surfaces of the upper and lower teeth, thus susceptible to breakage and not suitable for unstable teeth

presence of screw threads, screws or overly protuberant hooks which injure the mucous membrane of the lip and the cheek, etc.

These inventors therefore conducted extensive studies to perfect an apparatus for the treatment of anteroposterior maxillary displacements making it possible to solve the problems associated with the existing apparatuses.

This invention concerns an apparatus for the treatment of anteroposterior maxillary displacements using two rods fixed with a wedge shaped like a ball-hook passing through a tube welded on the metal frame of an orthodontic apparatus. These rods are characterized by the fact that they consist of a tube comprising at its end a flat surface, for example perpendicular to the axis of the tube and perforated with an eyelet through which passes the ball-hook. The rods used are light, thin and non-cumbersome.

The invention will be better understood in the light of the attached drawings 1 to 4.

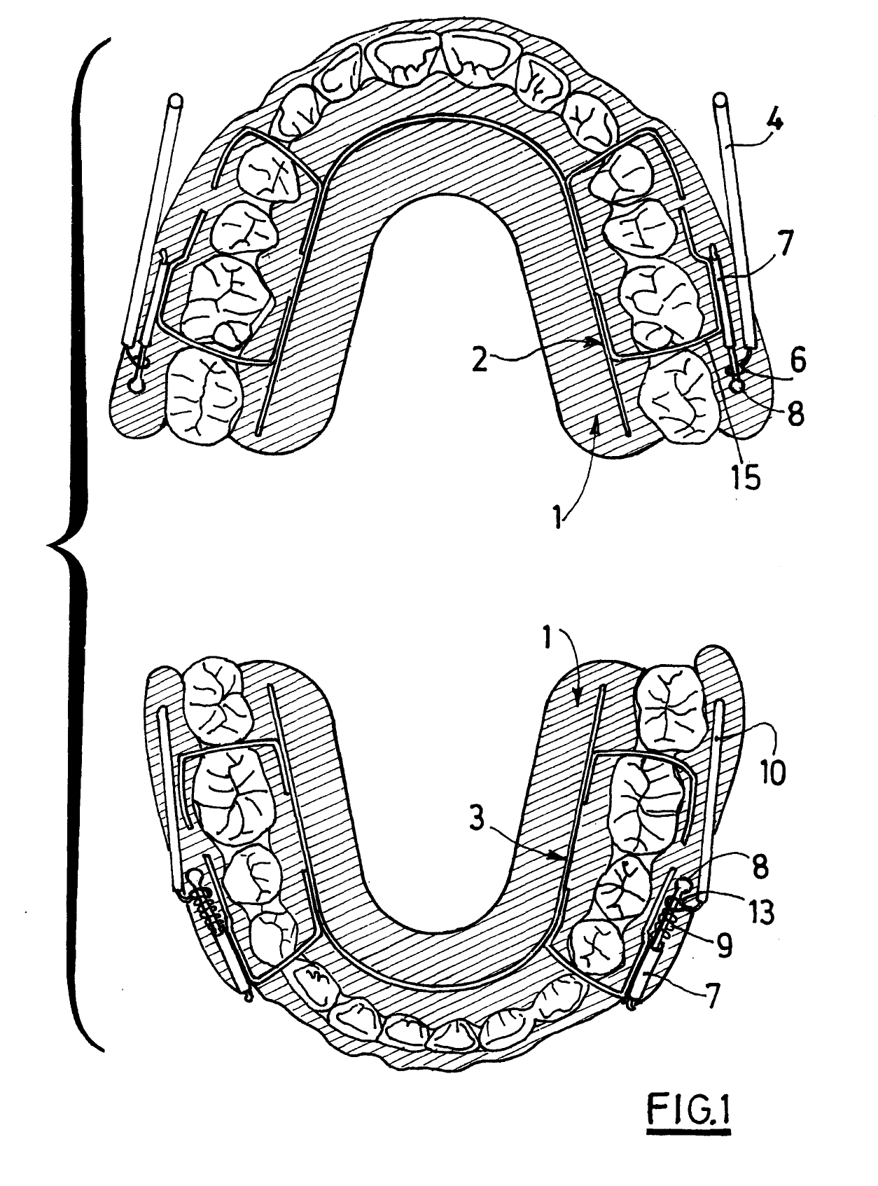

FIG. 1 depicts the positioning of an apparatus on the dental moldings.

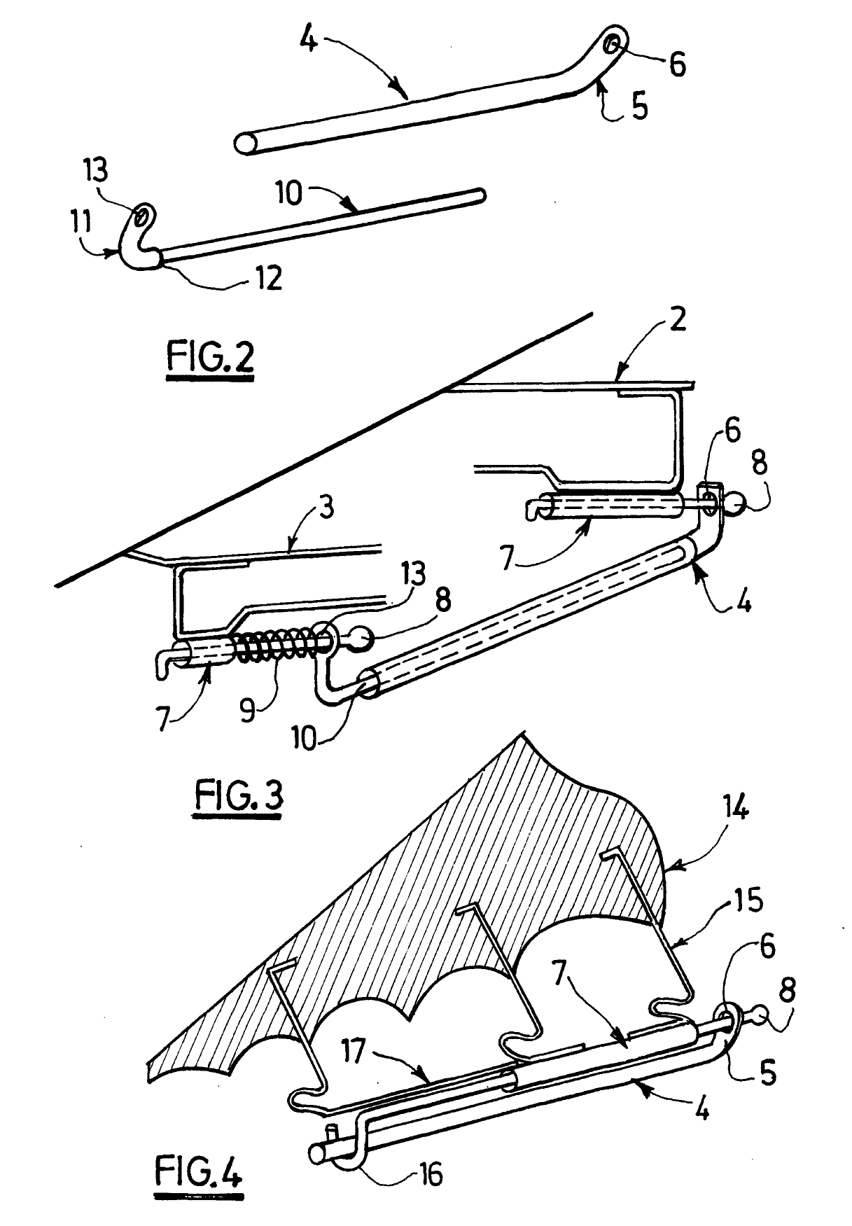

FIG. 2 depicts the system of two telescopic rods making it possible to connect the upper part and the lower part of an orthodontic apparatus.

FIG. 3 depicts the system for fastening of the rods onto the frame of two removable casts.

FIG. 4 depicts the fastening of a rod onto another widely used removable orthodontic apparatus.

FIG. 1 depicts a view from below of the upper and lower apparatuses positioned on dental moldings.

Removable resin casts (1) in which an upper metal frame (2) and a lower metal frame (3) are embedded have been depicted.

On the frame of the upper cast (2) there is fixed a female rod (4) by means of a ball-hook (8) passing through an eyelet (6) of the rod (4) and through a tube (7) welded to the upper metal frame (2). On the frame of the lower cast (3) there is fixed a male rod (10) by means of ball-hook (8) passing through an eyelet (13) of the rod (10) and through a tube (7) welded to the lower metal frame.

For the lower apparatus, the tube (7) is welded to the metal frame at the first lower premolars. For the upper apparatus, the tube (7) is welded on the metal frame at the upper molar.

There may be contemplated, as a variant, sliding between the eyelet (13) of the male rod (10) and the tube (7) welded to the frame of the lower apparatus, a compression spring (9) the purpose of which is to attenuate the propelling forces and to make possible a freedom of movement of the mandible in retroposition.

FIG. 2 depicts the system consisting of two telescopic rods making it possible to connect the upper part and the lower part of an orthodontic apparatus. The female rod (4) is a hollow tube one of the ends of which is a flat tube (5) perforated with an eyelet (6) and forming with the hollow tube an angle ranging between 90° and 120°, in particular equal to 90°. The male rod (10) is a shaft one end of which comprises a flat tube (11) welded to the shaft with a weld (12). The flat tube (11) is perforated with an eyelet (13) and it forms with the rod (10) an angle ranging between 60° and 90°, in particular equal to 90°. The shaft of the rod (10) slides into the tube of the rod (4).

FIG. 3 depicts the system for fastening of rods on the frame of two removable casts. The female rod (4) is fixed to the metal frame of the upper cast (2) by means of a wedge shaped like a ball-hook (8) passing [through] the eyelet (6) and through the tube 7 welded to the metal frame (2). The male rod (10) is fixed to the metal fame of the lower cast (3) by means of a wedge shaped like a ball-hook (8) passing through the eyelet (13) and through the tube (7) welded to the metal frame (3).

The shaft of the rod (10) slides into the tube of the rod (4). The two casts are fixed in the desired position by bending of the free end of the ball-hooks (8). The bent ends of the ball hooks are covered with resin and therefore they do not injure the lip and the cheek.

The principle of the system of fastening of rods on a single orthodontic apparatus (upper apparatus) is depicted on FIG. 4. The apparatus consists of a resin base (14) in which metal hooks (15) are fixed. The fastening of the rod (4) to the apparatus is implemented as in the case of the other Figures by means of the ball-hook (8), which passes through the eyelet (6) then through the tube (7) welded on the hook (15).

The ball-hook (8) terminates in a loop (16) surrounding the female rod (4) and making possible the locking of the free end of the upper female rod. This makes it possible for the child to wear the upper apparatus alone during the day and to connect a lower cast for the night, which was impossible with the known conventional removable propulsive devices.

A weld between the ball-hook (8) and the Adams shaft (17) also may be contemplated. This imparts a rigidity to the system. Thus the ball-hook (8) cannot turn.

FIG. 4 shows the universality of the system of fastening of the rods which makes it possible to use different known apparatuses.

In one embodiment of the invention, the removable apparatuses consist of two casts made of thermoformed resin in which there is embedded a metal frame consisting of occlusive metal bars which connect the inner arc with the outer arc.

In a preferred embodiment, the occlusive surfaces of the casts are not covered with resin. The propulsive device thus is made lighter and its metal frame imparts thereto a rigidity and a sufficient sturdiness so that the occlusive dental faces are able not to be covered with resin.

The fact that the teeth do not close on the resin resin [sic] prevents breakage of the apparatus and makes possible a normal dental occlusive function without difficulty in phonation or swallowing. The lightness of the apparatus makes it easier to accept during the day as well as at night.

The hollow at the upper surface of the teeth makes it possible for the baby teeth to fall out and for the permanent teeth to come through guided by the hole in the cast. The apparatus therefore is suitable for the unstable teeth of children, and it may be worn even when a baby tooth is beginning to shift and is becoming sensitive.

In another embodiment, one or both cast(s) do not comprise a front band.

In another embodiment, the dental surfaces are covered with resin.

The system of rods described in this invention may be fitted on metal hooks of any type of removable upper apparatus, such as palatine retractors, lingual shields or nighttime lingual sheaths, which comprise so-called Adams hooks. Thus by connecting to lower to the upper apparatus [sic], a mandibular propulsion can be brought about at the same time as a maxillary expansion. The system of rods therefore can be fitted on former apparatuses less expensive to manufacture.

The same invention is not limited to the embodiments described in the specification and the Figures. On the contrary, it encompasses all the variants within the limit of the appended claims.

1- Removable orthodontic apparatus with rods characterized in that the rods (4, 10) are fixed to a metal frame with a wedge shaped like a ball-hook (6) [sic] passing through a tube (7) welded on the metal frame (2, 3, 15) of said apparatus.

2- Removable orthodontic apparatus with rods according to claim 1, characterized in that it comprises an upper part and a lower part on which there are fixed respectively a female rod (4) and a male rod (10), the male rod sliding into the female rod.

3- Removable orthodontic apparatus with rods according to claim 1, characterized in that it consists of an upper apparatus with Adams hooks, in which the tube (7) is welded to said Adams hooks (15) and in which the ball-hook (8) terminates in a loop (16) surrounding the female rod (4), and possibly of a lower apparatus with male rods.

4- Removable orthodontic apparatus with rods according to claim 3, characterized in that the ball-hook (8) is welded on the Adams shaft (17).

5- Removable orthodontic apparatus with rods according to one of claims 1 to 4, characterized in that the female rod (4) is a hollow tube one end of which is a flat tube (5) perforated with an eyelet (6).

6- Removable orthodontic apparatus with rods according according [sic] to claim 5, characterized in that the flat tube (5) forms with the hollow tube an angle ranging between 90° and 120°.

7- Removable orthodontic apparatus with rods according to claim 2, characterized in that the male rod (10) is a shaft one end of which comprises a flat tube (11) welded to the shaft with a weld (12) and perforated with an eyelet (13).

8- Removable orthodontic apparatus with rods according to claim 7, characterized in that the flat tube (11) forms with the shaft an angle ranging between 60° and 90°.

9- Removable orthodontic apparatus with rods according to one of claims 1, 2, 5 or 6, characterized in that a compression spring (9) is slid between the eyelet (13) of the male rod (10) and the tube (7) welded to the metal frame (3) of the lower apparatus.
